(19) United States
(12) Patent Application Publication
(10) Pub. No.: US 2024/0179390 A1
(43) Pub. Date: May 30, 2024

(54) Participant Video Communication Devices as Host and Attendee, and Video Conferencing System

(71) Applicant: AmTRAN TECHNOLOGY CO., LTD, New Taipei City (TW)

(72) Inventor: Kuo-Chih Lo, New Taipei City (TW)

(73) Assignee: AmTRAN TECHNOLOGY CO., LTD, New Taipei City (TW)

(21) Appl. No.: 18/241,894

(22) Filed: Sep. 3, 2023

(30) Foreign Application Priority Data
Nov. 29, 2022 (TW) 111145613

(51) Int. Cl. H04N 23/58; G06F 3/01; G06T 7/13; G06T 7/73; H04N 5/268; H04N 23/611; H04N 23/69; H04N 23/698

(52) U.S. Cl. CPC H04N 23/58; G06F 3/013; G06T 7/13; G06T 7/73; H04N 5/268; H04N 23/611; H04N 23/69; H04N 23/698; G06T 2207/10016; G06T 2207/30201

(57) ABSTRACT

A network video communication device includes a transmission circuit; a display; an image capture circuit, for capturing a first real-time image; and a processing circuit; wherein the network video communication device performs connecting a server and joining an online video conference; capturing the first real-time image of a first user; receiving a second video signal comprising a second real-time image captured by a second video communication device; displaying a video conference screen comprising the second real-time image; determining an identity or a status of the first user; processing the first real-time image of the first user to generate a first user information; transmitting the first user information to the second video communication device; receiving the second video signal comprising the adjusted real-time image with an adjusted field of view; displaying the second real-time image with the adjusted field of view in the video conference screen.

### BACKGROUND OF THE INVENTION

### 1. Field of the Invention

The present invention relates to video communication devices as host and attendee of a video conference and a video conferencing system, and more particularly, to a video conferencing system that automatically adjusts the view of captured video by a second video communication device according to user information from a first video communication device.

### 2. Description of the Prior Art

The demand for video conference has increased due to the advancement of technology. The current video conferencing devices currently may have the camera capturing real-time video images of local users and automatically focus the view on a presenting user's face according to real-time speaking status of the participating users in the video conference. However, if the presenting user is describing a local object in the real space during the video conference, such as a sample on a table, which cannot be captured by camera with the presenting user' face or is far to the camera, the view of the camera capturing real-time video images cannot automatically focus on the real object, and other participating users may not see the real object in detail on the video conference screen. The presenting user needs to manually adjust the view of the camera or the position of the object in order to show the object on the video conference screen. Under such circumstances, how to make the video conferencing device automatically focus the camera view on a real object when a participating user of a video conference is discussing about the object, such that other remote participants can see the video conferencing image of the object simultaneously, has become a goal of the industry.

### SUMMARY OF THE INVENTION

Therefore, the purpose of the present invention is to provide a network video communication device as host, a network video communication device as attendee and a method of video conference image processing to improve the drawback of the prior art.

The embodiment of the present invention discloses a network video communication device, comprising: a transmission circuit; a display; an image capture circuit, for capturing a first real-time image; and a processing circuit, coupled to the transmission circuit, the image capture circuit and the display; wherein the network video communication device performs following steps: controlling, by the processing circuit, the transmission circuit to connect a server and join an online video conference as one of a plurality of participants of the online video conference; controlling, by the processing circuit, the image capture circuit to capture the first real-time image of a first user local to the network video communication device; receiving, by the transmission circuit, a second video signal, wherein the second video signal comprise a second real-time image captured by a second video communication device which is another one of the participants of the online video conference; controlling, by the processing circuit, the display to display a video conference screen, wherein the video conference screen comprises the second real-time image; determining, by the processing circuit, an identity or a status of the first user corresponding to the online video conference; processing, by the processing circuit, the first real-time image of the first user to generate a first user information, wherein the first user information comprises an eye gaze direction of the first user if the identity or the status of the first user meets a requirement; controlling, by the processing circuit, the transmission circuit to transmit the first user information to the second video communication device; receiving, by the transmission circuit, the second video signal comprising the adjusted real-time image with an adjusted field of view, wherein the adjusted field of view is directed to a focus area corresponding to the eye gaze direction of the first user; controlling, by the processing circuit, the display to display the second real-time image with the adjusted field of view in the video conference screen; wherein the second real-time image with the adjusted field of view is transmitted to the participants of the online video conference.

The embodiment of the present invention discloses a network video communication device, comprising: a transmission circuit; an image capture circuit, for capturing real-time images; and a processing circuit, coupled to the transmission circuit and the image capture circuit; wherein the network video communication device performs following steps: controlling, by the processing circuit, the transmission circuit to connect a server and join an online video conference as one of a plurality of participants of the online video conference; controlling, by the processing circuit, the image capture circuit to capture a first real-time image of a user local to the network video communication device; transmitting, by the transmission circuit, the first real-time image to at least one of the other participants of the online video conference; receiving, by the transmission circuit, a first user information from a remote network video communication device, wherein the first user information comprises an eye gaze direction of a remote user of the remote network video communication device, the remote user is recognized as having a first identity or in a first status corresponding to the online video conference, and the remote video communication device is the at least one of the other participants of the online video conference; processing, by the processing circuit, the first user information and controlling the image capture circuit to capture a second real-time image, wherein the second real-time image is captured with a field of view adjusted corresponding to the eye gaze direction of the remote user; and transmitting, by the transmission circuit, a video signal including the second real-time image with the adjusted field of view to the at least one of the other participants of the online video conference.

The embodiment of the present invention discloses a method of video conference image processing, for a network video communication device comprising a transmission circuit, a display, an image capture circuit, a microphone and a processing circuit, the method of video conference image processing comprising: connecting a server and joining an online video conference as one of a plurality of participants of the online video conference, wherein the participants of the online video conference comprise at least the network video communication device and a second video communication device remote to the network video communication device; capturing a first real-time image of a first user local to the network video communication device; capturing a first real-time audio local to the network video communication device; receiving a second video signal, wherein the second video signal comprise a second real-time image captured by the second video communication device; displaying a video conference screen including the second real-time image; determining an identity of the first user corresponding to the online video conference, or determining a status of the first user based on the first real-time image of the first user or the first real-time audio; processing the first real-time image of the first user to generate a first user information if the identity or the status of the first user meets a requirement, wherein the first user information comprises an eye gaze direction of the first user; transmitting the first user information to the second video communication device; receiving the second video signal comprising the second real-time image with an adjusted field of view, wherein the adjusted field of view is directed to a focus area corresponding to the eye gaze direction of the first user; and displaying the video conference screen including the second real-time image with the adjusted field of view.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a video conference system according to an embodiment of the present invention.

FIG. 2 is a schematic diagram illustrating a host video communication device according to an embodiment of the present invention.

FIG. 3 is a schematic diagram illustrating a participant video communication device according to an embodiment of the present invention.

FIG. 4A is a schematic diagram illustrating an image capture circuit according to an embodiment of the present invention.

FIG. 4B is a schematic diagram illustrating a plurality of fields of view corresponding to a plurality of photographic lenses according to an embodiment of the present invention.

FIG. 5 is a flowchart of a host information generating method according to an embodiment of the present invention.

FIG. 6 and FIG. 7 are schematic diagrams of a gaze direction of a host according to an embodiment of the present invention.

FIG. 8 is a schematic diagram of the gaze direction of the host according to another embodiment of the present invention.

FIG. 9 is a schematic diagram of a relative position of the host and a first image capture circuit according to an embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. Also, the term “couple” is intended to mean either an indirect or direct electrical connection. Accordingly, if one device is coupled to another device, that connection may be through a direct electrical connection, or through an indirect electrical connection via other devices and connections.

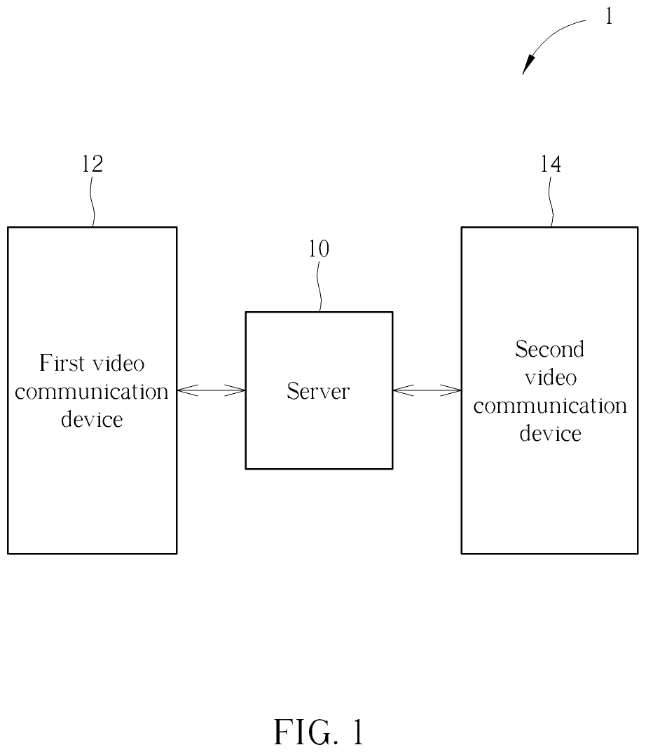

Please refer to FIG. 1. FIG. 1 is a schematic diagram illustrating a video conference system 1 according to an embodiment of the present invention. The video conference system 1 includes a server 10, a first video communication device 12 and a second video communication device 14. The server 10 connects to the first video communication device 12 and the second video communication device 14 via network. Users may utilize the video communication devices 10 and 12 to establish a video conference and join the video conference on the server 10 remotely, or call another user or video communication device to proceed a video conference communication. The server 10 may receive video information captured by the first video communication device 12 and the second video communication device 14 respectively, integrate the video information and transmit the integrated video information to the video communication devices participating in the video conference. In addition, the video conference system 1 of the embodiments of the present invention may include two or more video communication devices connected to the server 10 for participating the video conference. The server 10 or the video communication devices participating the video conference may analyze the captured video information and determine a priority order of the participating video communication devices at any time according to the settings of the video conference. For example, according to the video information currently received, the server 10 determines that the first video communication device 12 is currently the host device, which should be assigned with higher priority, and the second video communication device 14 is currently an attendee device. In this way, the host device and the attendee device may receive the priority order of the participating video communication devices from the server 10 and respectively display the collected video information transmitted from the server 10 on the video conference screen accordingly, wherein the video information of the host device is prioritized on the video conference screen. It should be noted that during the video conference, the server 10 may analyze the video information and determine identities and priority order of the video communication devices at any time, or the user who manages or hosts the video conference can actively set new priorities to the video communication devices in the video conference. In some embodiments, only the first video communication device 12 and the second video communication device 14 are connected to the server 10 for holding the video conference, and the server 10 may respectively transmit video stream signals containing the video information captured by the two video communication devices to the other party, or integrate the video information captured by the two video communication devices into one video conference screen and then transmit video signals containing the video conference screen to the two video communication devices, wherein the screen areas displaying the captured video information from the two video communication devices may have the same size or different sizes on the video conference screen. For example, when it is determined that a user is presenting, the video conferencing screen will have a larger screen area showing the image of the presenting user captured by one of the video communication device, which is determined as the host device at this time. Alternatively, a larger screen area showing the video information of a specific user captured by a video communication device, which is set as the host device of the video conference, may be fixed on the video conference screen. In addition, the users may operate the video communication devices to set the size of the screen areas or display mode of the video conference screen and video information from the video communication devices. In some embodiments, the server 10 connects with two or more video communication devices for holding the video conference and constantly determines a priority order of the video communication devices participating the video conference in real time. The server 10 determines the captured video information from which video communication devices should be displayed and transmitted according to the determined priorities in real time, wherein the video information with higher priorities are transmitted and displayed in larger screen areas on the video conference screen. For example, the video conference screen has the largest screen area displaying the video information of the host or presenting user captured by the host device, which has the highest priority. Other screen areas displaying the video information captured by video communication devices with lower priorities may be smaller or such video information is not displayed. For the convenience of description, some of the embodiments of the present invention take the first video communication device 12 as the host device and the second video communication device 14 as an attendee device, which are only exemplary descriptions. Those skilled in the art may properly change the identities of the first video communication device 12 and the second video communication device 14 according to the requirements.

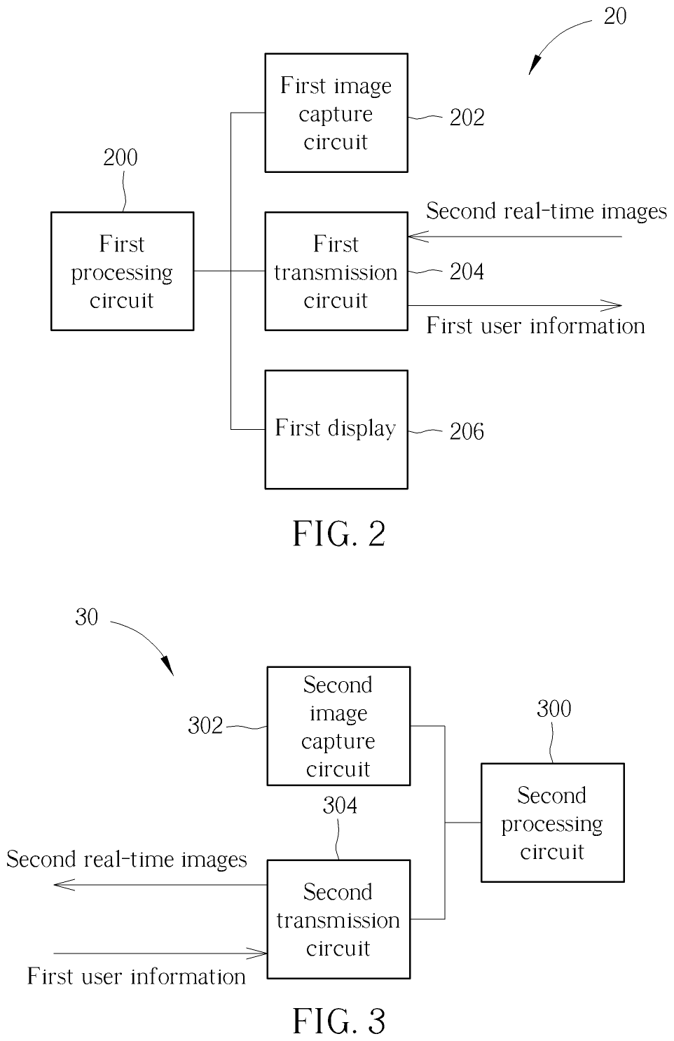

Specifically, please refer to FIG. 2. FIG. 2 is a schematic diagram illustrating a host device 20 according to an embodiment of the present invention. The first video communication device 20 as the host device includes a first processing circuit 200, a first image capture circuit 202, a first transmission circuit 204 and a first display 206. The first transmission circuit 204, such as a wired or wireless network interface, is utilized for receiving video signals containing a video conference screen or real-time images, provided by other video communication devices participating the video conference, from the server. The first display 206, such as a display panel or projector, is utilized for displaying the video conference screen, and the first image capture circuit 202, such as a built-in camera or external camera device, is utilized for capturing a first real-time image, which normally focuses on the user's face or a group of users, at the site of the first video communication device 20. The first processing circuit 200, such as a central process or a system-on-chip, is coupled to the first image capture circuit 202, the first transmission circuit 204 and the first display 206, is utilized for controlling the first image capture circuit 202 to capture the first real-time images and providing the first real-time images to be displayed in the video conference screen on the first display 206. The first processing circuit 200 is also utilized for analyzing the first real-time images and obtaining the first user information of a first user at the site of the first video communication device 20. Specifically, the first user information may be utilized for determining that the first user is focusing on which image content on the video conference screen. For example, the items of the first user information may include the distance to the first user, the face position of the first user, the eye position of the first user and the eye gaze direction of the first user, but not limited thereto. In some embodiments, the step of obtaining the first user information may be performed by the server 10. Alternatively, the first processing circuit 200 may analyze the first real-time image and generate part of the first user information items, for example, the face position of the first user, and the server 10 analyzes and generates other parts of the first user information items.

Furthermore, the first processing circuit 200 of the first video communication device 20 may perform the following steps: controlling the first transmission circuit 204 to transmit the first user information to the second video communication device 30 through the server 10; receiving second real-time images captured by the second video communication device 30, which has a second field of view controlled according to the first user information transmitted by the first transmission circuit 204; and controlling the first display 206 to display the second real-time images which have been captured after controlling the camera view of the second video communication device 30. For example, the server 10 determines that the first video communication device 20 is currently the host video communication device if the identity of the first user, who logs in the system, is recognized as the host, the moderator, or the presenter of the video conference, or the status of the first user is detected as continuing to speak over a period of time at the location of the first video communication device 20. During the video conference, the server 10 transmits the second real-time images to the first video communication device 20 for displaying, and the server 10 also transmits the at least one first user information collected by the first video communication device 20 to the second video communication device 30. The second video communication device 30 determines that the first user is currently watching a certain position of the second real-time images according to at least part of the first user information; that is, the line-of-sight of the first user focus on the position of an Object-of-Interest's image in the previous second real-time images displayed by the first video communication device 20. The second video communication device 30 centers the camera view on the line-of-sight focus position in the previous second real-time images and enlarges the object's image captured at the line-of-sight focus position. In this way, the new second real-time images, captured after abovementioned adjustments, are transmitted to the first video communication device 20 and displayed on the first display 206. The first user can watch the details of the Object-of-Interest more clearly or direct the discussion to the Object-of-Interest and make targeted speeches.

On the other hand, please refer to FIG. 3. FIG. 3 is a schematic diagram illustrating a second video communication device 30 according to an embodiment of the present invention. The second video communication device 30 includes a second processing circuit 300, a second image capture circuit 302 and a second transmission circuit 304. The second image capture circuit 302, such as a built-in camera or external camera device, is utilized for capturing a second real-time images at the site of the second video communication device 30. The second transmission circuit 304, such as a wired or wireless network interface, is utilized for transmitting the second real-time images to other communication devices and receiving video signals containing a video conference screen or real-time images provided by other video communication devices participating the video conference through the server 10. The second transmission circuit 304 is also utilized for receiving the first user information generated by remote video communication devices, which collect and process to generate the first user information from the captured real-time images. The second processing circuit 300, such as a central process or a system-on-chip, is coupled to the second image capture circuit 302 and the second transmission circuit 304. The second processing circuit 300 is utilized for controlling the second image capture circuit 302 to capture the second real-time images and providing the second real-time images to be displayed in the video conference screen. The second processing circuit 300 is also utilized for adjusting the field of view of the second image capture circuit 302 according to the first user information, which captures the second real-time images with the adjusted field of view, and controlling the second transmission circuit 304 to transmit the second real-time images, captured after adjustments, to the first video communication device 20 and the other participating video communication device through the server 10. For example, the second processing circuit 300 may control the second image capture circuit 302 to capture the real-time image of the user participating the online video conference through the second video communication device 30. After receiving the first user information from the first video communication device 20 for a period of time, the second processing circuit 300 may determine that the remote user of the first video communication device 20 is gazing an image position, such as the image of an Object-of-Interest, in the second real-time images over a period of time. The second processing circuit 300 then controls the second image capture circuit 302 to center the camera view on the image position in the previous second real-time images, i.e. the second image capture circuit 302 center the field of view to the direction toward the focus position of the remote user of the first video communication device 20, and zoom-in to capture real-time image. The second image capture circuit 302 captures the enlarged real-time images of the Object-of-Interest at the focus position of the remote user of the first video communication device 20. The enlarged real-time images of the Object-of-Interest are transmitted by the second transmission circuit 304 as the new second real-time images to the first video communication device 20 through the server 10 and the first display 206 displays the new second real-time images in the video conference screen. Thus, the user of the first video communication device 20 can see the Object-of-Interest more clearly on or make comments about displayed details of the Object-of-Interest.

It should be noted that FIG. 2 and FIG. 3 are the embodiments of the present invention, and those skilled in the art may appropriately add other devices according to the system requirements. For example, motherboard, power supply, connection cable, microphones, audio output interfaces, etc., but not limited thereto. Alternatively, the video conference system 1 may be implemented with appropriate devices or equipment. For example, the first image capture circuit 202 and the second image capture circuit 302 may be built-in or external cameras. The video conference system 1 may utilize microphone arrays to collect sounds for noise cancellation and suppression, or utilize audio processing circuits for amplifying desirable sounds.

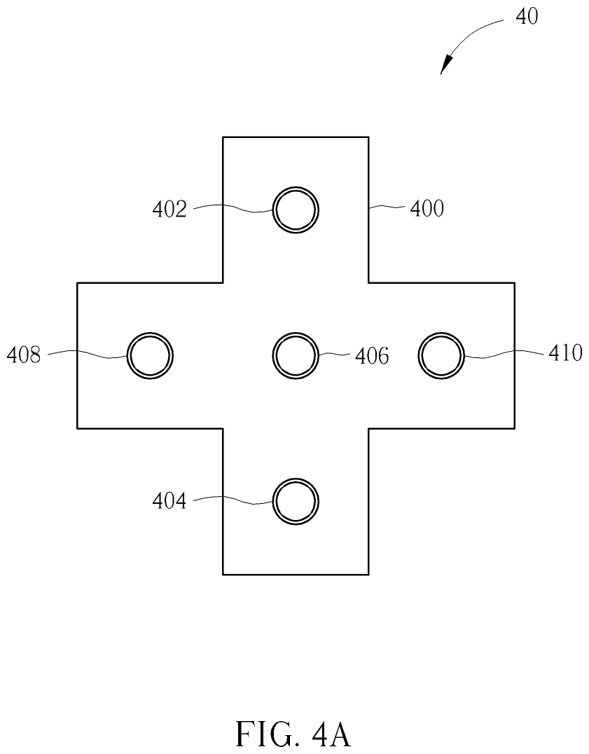

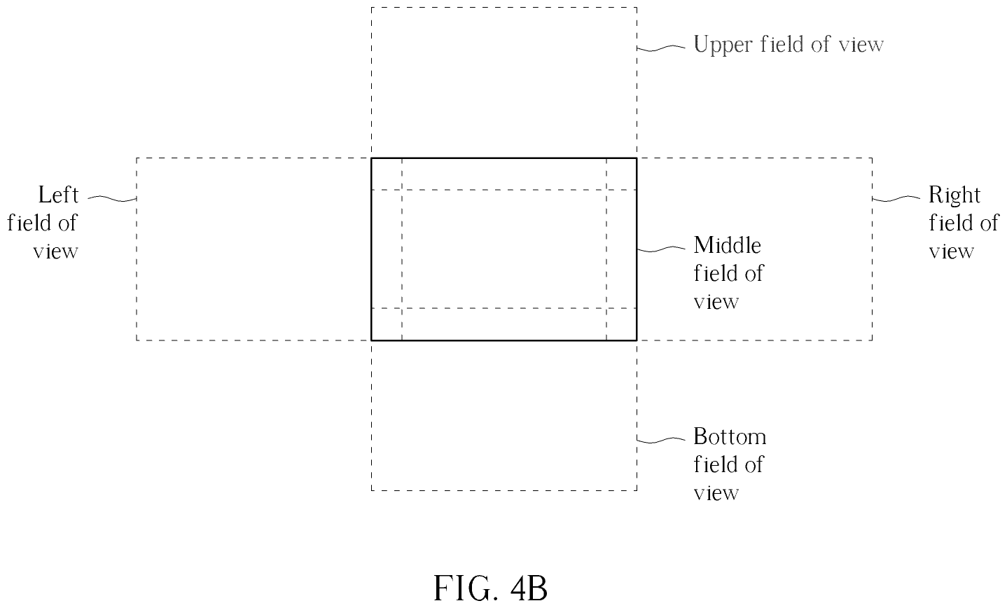

On the other hand, in order to provide a clearer and wider field of view for the real-time images captured by the first image capture circuit 202 and the second image capture circuit 302, in an embodiment, the first image capture circuit 202 and the second image capture circuit 302 may have multiple photographic lenses or connected camera devices. For example, the first image capture circuit 202 and the second image capture circuit 302 can include a camera array with a plurality of photographic lenses. The plurality of photographic lenses may be utilized for simultaneously capturing multiple real-time images. The first processing circuit 200 may select at least one captured images to merge into the first real-time image for transmission, while the second processing circuit 300 may select at least one captured images, according to the received first user information, to merge into the second real-time image for transmission. In this way, the first and second image capture circuits can provide clearer real-time images with wider field of view capabilities for the video conference participants. For example, please refer to FIG. 4A and FIG. 4B. FIG. 4A is a schematic diagram illustrating an image capture circuit 40 according to an embodiment of the present invention. The image capture circuit 40 may be a camera module including a plurality of photographic lenses with image sensors, such as an upper photographic lens 402, a bottom photographic lens 404, a middle photographic lens 406, a left photographic lens 408 and a right photographic lens 410, configured on a module housing 400. Please refer to FIG. 4B. FIG. 4B is a schematic diagram illustrating a plurality of fields of view corresponding to the plurality of photographic lenses respectively according to an embodiment of the present invention. As shown in FIG. 4B, the upper photographic lens 402, the bottom photographic lens 404, the middle photographic lens 406, the left photographic lens 408 and the right photographic lens 410 may capture an upper real-time image, a bottom real-time image, a middle real-time image, a left real-time image and a right real-time image respectively with an upper field of view, a bottom field of view, a middle field of view, a left field of view and a right field of view respectively. Therefore, these captured real-time images may be processed in order to provide wider field of view images during the video conference. It should be noted that the middle field of view partially overlaps with the upper field of view, the bottom field of view, the left field of view and the right field of view. T the first processing circuit 200 and the second processing circuit 300 may select part of the images captured by the photographic lenses to merge into the first real-time image and the second real-time image for video conferencing. For example, when the user of the first video communication device 12 gazes toward the left area of the first display 206, the first processing circuit 200 or the server 10 provides the first user information indicating the gaze direction or focus area of the remote user to the second video communication device 30. If the first user information indicates the gaze direction of the remote user is toward left or the focus area is at the left side, the second processing circuit 300 selects the captured left real-time image and the captured middle real-time image to merge. The selected real-time images are processed and adjusted into the second real-time image of the second video communication device 30 for transmission. Furthermore, the upper photographic lens 402, the bottom photographic lens 404, the middle photographic lens 406, the left photographic lens 408 and the right photographic lens 410 of the image capture circuit 40 may be stereo cameras with specification, for example, of 12 MP@120 Hz. In this way, the captured images of the image capture circuit 40 can cover a minimum field of view of 130 degrees horizontally and 105 degrees vertically. The processing circuit may select partial images within the captured images corresponding to a selected field of view in these degree ranges and merge the selected partial images into the real-time image for video conferencing. For example, the processing circuit may instantly zoom-in part of the captured images corresponding to the remote user's focus area, and merge the zoom-in images into the real-time partial close-up images with clearer details. The processing circuit may also instantly detect any object within part of the captured images corresponding to the remote user's focus area, such as edge, color or distance detections, and set the zoom-in parameters accordingly in order to provide the object close up real-time image during the video conference. It should be noted that, the plurality of photographic lenses may also be other types of image sensors with various photographing specifications and capabilities, and those skilled in the art may properly select the type and specification of the photographic lens to meet the system requirements.

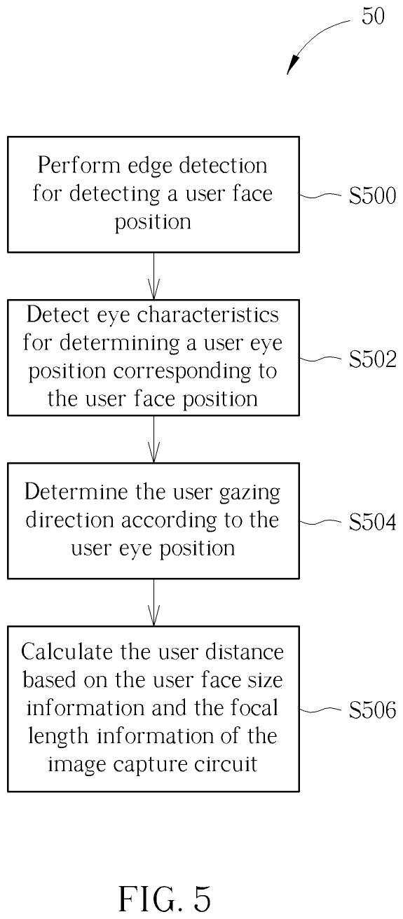

The process of the first processing circuit 200 obtaining the first user information from the captured first real-time image may be summarized as a user information obtaining method 5. As shown in FIG. 5, the user information obtaining method 5 includes the following steps:

Step S500: Perform edge detection for detecting a user face position.

Step S502: Detect eye characteristics for determining a user eye position corresponding to the user face position.

Step S504: Determine the user gazing direction according to the user eye position.

Step S506: Calculate the user distance based on the user face size information and the focal length information of the image capture circuit.

According to the user information generation method 5, the first processing circuit 200 utilizes an edge detection method to analyze the user face position within the first real-time image in the step S500 and S502. The first processing circuit 200 also utilizes a deep learning module to detect the user eye position within the first real-time image based on eye characteristics. The deep learning module may be a deep neural network (DNN) of an open source computer vision library (OpenCV), but is not limited thereto. The user information generation method 5 may be simultaneously applied to multiple users appearing in the first real-time image. In addition, the edge detection method is well known to those skilled in the art, and will not be repeated hereafter. As mentioned above, the first video communication device 20 is equipped with a microphone component or a microphone array for capturing real-time local sounds. Instead, the first video communication device 20 may connect to a remote microphone device at a different location to capture real-time sounds of the user at the location. The first processing circuit 200 may perform real-time calculations such as Direction of Arrival (DOA) on the captured audio to determine the position of the user who is speaking, and dynamically control the first image capture circuit 202 to zoom-in the speaking user's face or upper body and capture real-time images accordingly, which will be transmitted to other video communication devices participating in the video conference through the server 10. In the embodiment of the present invention, the second video communication device 30 utilizes the second image capture circuit 302 to capture the front panoramic images as the second real-time which are transmitted to other images, participating video communication devices through the server 10. In the embodiment of the present invention, the second processing circuit 300 also simultaneously detects the positions of local users from the captured real-time images or the real-time audio sounds captured by the microphone. In the embodiment of the present invention, the second processing circuit 300 dynamically controls the second image capture circuit 302 to zoom-in the speaking user's face or upper body and capture the second real-time images accordingly, which are transmitted to other video communication devices participating in the video conference through the server 10.

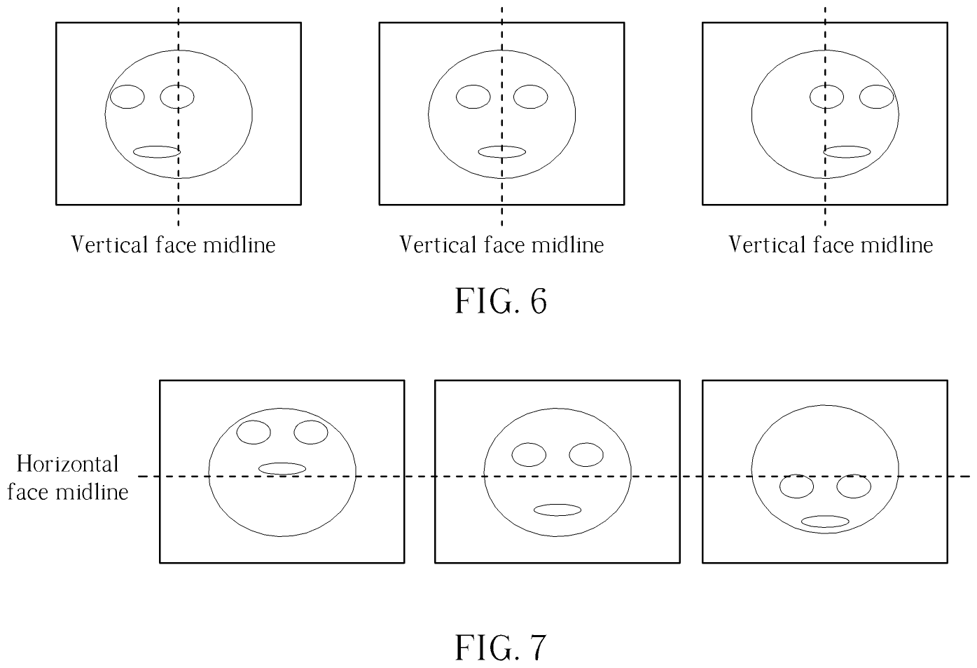

In step S504, the first processing circuit 200 may determine the user's line-of-sight direction based on the eye position. Please refer to FIG. 6 and FIG. 7. FIG. 6 and FIG. 7 are schematic diagrams illustrating the user's line-of-sight directions in the real-time video conferencing images according to an embodiment of the present invention. The images of the user's face, which can obtained at the user's face position in the captured real-time images, can be processed to find a horizontal face midline and a vertical face midline. The first processing circuit 200 may compare the user's eye positions with the horizontal face midline and the vertical face midline and determine user's line-of-sight direction instantly. For example, as shown in FIG. 6, when the user looks to the right/middle/left, that is, the user's current line-of-sight direction is toward the right/middle/left, the eye positions are shifted to the right/middle/left relative to the vertical face midline. Similarly, as shown in FIG. 7, when the user looks to the up/middle/bottom, that is, the user's current line-of-sight direction is toward the up/middle/bottom, the eye positions are shifted to the up/middle/bottom relative to the horizontal face midline. In this way, the second processing circuit 300 can determine the user's line-of-sight focus position on the video conference screen according to the current line-of-sight direction. This allows the second processing circuit 300 to adjust the camera view of the second real-time images according to the remote user's line-of-sight focus position, enabling the remote user to more clearly focus on or make comments about the image content of the important object presented in the second real-time image, so as to encourage discussions in the video conference.

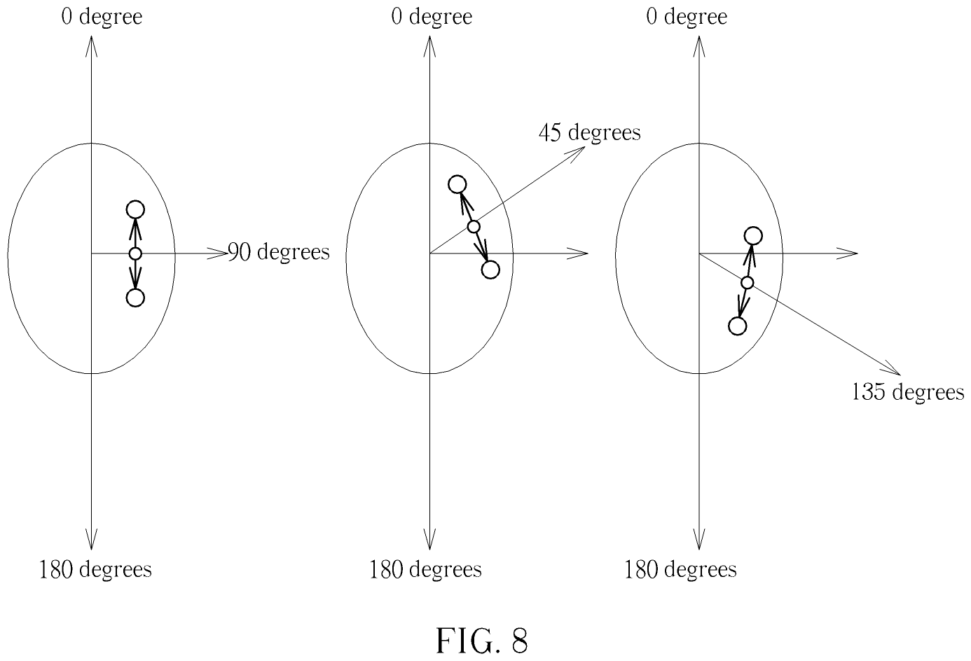

Furthermore, please refer to FIG. 8. FIG. 8 is a schematic diagram illustrating the top view of the exemplary horizontal line-of-sight directions of the user according to an embodiment of the present invention. The image of the user's face can be processed to find the eye positions, center of the eyes, and the center of the face. The first processing circuit 200 may estimate a line-of-sight angle based on the distance between the center of the eyes, and the center of the face. More specifically, first processing circuit 200 can find the center of the face based on the image of the user's face and estimate the line-of-sight angle based on the center of the eyes and the center of the face. For example, as shown in FIG. 8, the horizontal line-of-sight angle may be defined as an angle between 0 and 180 degrees to a vertical cross-section plane passing through the center of the face, wherein 0 degree indicates that the line-of-sight is directed to the leftmost side, 90 degree indicates that the line-of-sight is directed to the center or front side, and 180 degree indicates that the line-of-sight is directed to the rightmost side. The line-of-sight angle of the user may also include the vertical line-of-sight angle, which can be estimated by a similar method replacing the vertical cross-section plane to a horizontal cross-section plane. The first processing circuit 200 may transmit the line-of-sight angle to the second video communication device 30. In the embodiment of the present invention, the first processing circuit 200 determines whether the user's sight is maintained at a specific angle for a period of time, or whether the user's sight is maintained at a specific angle while the user is speaking for a period of time. For example, if the user speaks for more than 5 seconds while looking at a specific angle, the first processing circuit 200 transmits the line of sight angle to the second video communication device 30. In the embodiments of the present invention, while the first processing circuit 200 determines whether the user is speaking for a period of time or the user's sight is maintained at a specific angle for a period of time, the first processing circuit 200 will also determine whether user's line of sight angle changes beyond a threshold, such as 5 to 20 degrees, during a period of time. If the user's line-of-sight angle changes by more than the threshold value, the first processing module 200 does not transmit any line-of-sight angle. If the user's line of sight angle does not change by more than the threshold value during a period of time, the first processing module 200 transmits the line-of-sight angle to the second video communication device 30. In the embodiments of the present invention, if the user's line of sight angle does not change by more than the threshold value during a period of time, the user's line-of-sight angle transmitted by the first processing circuit 200 to the second video communication device 30 may be any of the user's latest line-of-sight angle, the average value of the user's line-of-sight angle during the period of time, the line-of-sight angle that the user maintains for the longest time during the period of time, or any combination of such angles. In this way, the second processing circuit 300 may more accurately determine the focus position of the user's sight based on the line-of-sight angle and adjust the field of view for the second real-time images accordingly. The user at the first video communication device 20 may more clearly observe the image content of the important object at the focus position of the user's sight in the second real-time images, so as to discuss with others in the video conference.

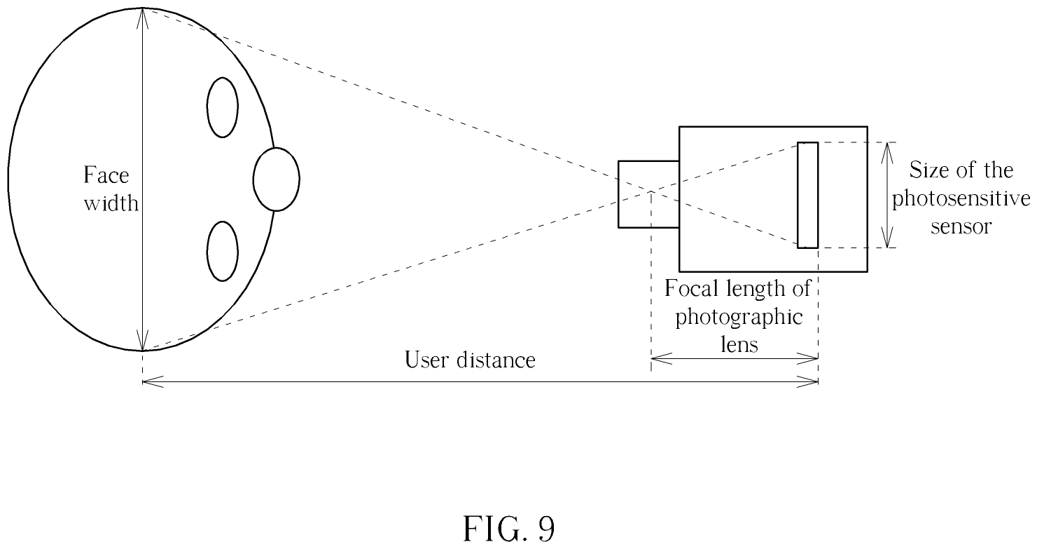

In step S504, the first processing circuit 200 may calculate the user distance based on the user face size information and the focal length information of the image capture circuit. Please refer to FIG. 9. FIG. 9 is a schematic diagram illustrating the relative positions of the user and the first image capture circuit 202 according to an embodiment of the present invention. It should be noted that only the relative positions of the user and the middle photographic lens 406 are shown in FIG. 9, those skilled in the art may add the upper photographic lens 402, the bottom photographic lens 404, the middle photographic lens 406, the left photographic lens 408 and the right photographic lens 410 into the embodiment and calculate the user distance according to the system requirements. In detail, the first processing circuit 200 may calculate the user distance based on the average size of a human faces, the size of a photosensitive sensor of the middle photographic lens 406 and the focal length of the middle photographic lens 406. The user distance formula is as following equation (1):

$$the user distance = \frac{( the focal length of the photographic lens * the average size of human face )}{the size of the photosensitive element of the photographic lens} \qquad ( 1 )$$

For example, the average size of a man's face is 14.5 cm, and the average size of woman's face is 13.3 cm. It should be noted that the first processing circuit 200 may also estimate a face width of the user when detecting the face position. In this way, the average size of human face in the user distance formula may be replaced by the estimated user's face width to calculate the user distance. In the embodiments of the present invention, the first processing circuit 200 or the second processing circuit 300 may analyze the captured real-time images to calculate the user distance, so as to determine whether the user is participating the video conference. When it is determined that a person, not participating the video conference, is unexpectedly appearing in the captured real-time image, the first processing circuit 200 or the second processing circuit 300 may process to mask or cut the image of the unexpected person from the captured real-time image in order to prevent the unexpected person appearing in the video conference screen.

As described above, the identity of the users who use the first video communication device 20 and the second video communication device 30 to participate the video conference may be dynamically changed at any time, and the video conference may involve more than two video communication devices at different locations. When a user speaks, the video communication device at the location may detect the user's orientation with real-time audio processing and capture the real-time images of the speaking user. In the embodiments of the present invention, when the user continues to speak for a period of time without interruption, e.g., after speaking continuously for more than 7 or 15 seconds, the video communication device or the server 10 may set the user's identity as the current host or speaker of the video conference, and notify the users of other video communication devices participating the video conference as non-speaking participants. At this time, the line-of-sight of the host or speaker will be detected by the video communication device used by the host or speaker. The local video communication device or the server 10 determines where is the focus area of the video conference screen being watched by the host or speaker according to the video screen currently displayed by the local video communication device, so as to notify the remote video communication device providing real-time image corresponding to the focus area of the video conference screen, that is, to notify the remote video communication device which provides the real-time image displayed on the screen area being watched by the host or speaker. At this time, the local video communication device used by the moderator or the speaker may be regarded as the above-mentioned first video communication device 20, and the remote video communication device providing real-time image corresponding to the focus area of the video conference screen watched by the moderator or the speaker may be regarded as the second video communication device 30. In this way, the remote video communication device may dynamically adjust the camera to capture real-time image according to the line-of-sight of the host or speaker, and the host or speaker may freely to watch the video conference screen to control and adjust the fields of view of the real-time images provided by any of the remote video communication devices. The real-time image with adjusted field of view is captured by the remote video communication device and transmitted to all video communication devices in the video conference through the server 10 for displaying on the video conference screen. In this way, all participating users may watch the real-time image with adjusted field of view and know what the current speaker's focus on the video conference screen is. Simultaneously, the real-time image and real-time audio of the speaking user captured by the image capture circuit and the microphone are also transmitted to all participating video communication devices in the video conference through the server 10. In some embodiments of the present invention, the second processing circuit 300 performs object detection and recognition on the captured real-time images with field of view adjusted according to the line-of-sight angle of the host or speaker, and processes the real-time images to enlarge the image of the recognized Object-of-Interest for displaying on the video screens. Alternatively, the second processing circuit 300 may control to the second image capture circuit 302 to capture multi-angle real-time images of the Object-of-Interest and provide for the participating users to observe. The Objects-of-Interest may be product samples to be discussed in video conference, a whiteboard with discussion items, images displayed by the projectors or display monitors, and so on. In the embodiments of the present invention, when the second image capture circuit 302 of the second video communication device 30 has a plurality of photographic lenses, or second video communication device 30 connects to other photographic devices, the second video communication device 30 may simultaneously capture a plurality of real-time images. The second processing circuit 300 processes the real-time images and then transmits to the server 10. For example, part of the captured real-time images of the second video communication device 30 are captured with the adjusted field of view, which is controlled according to the line-of sight angle of the remote host or speaker, so the part of the captured real-time images may be the images of Object-of-Interest or displayable information that the remote host or speaker is focusing on. In addition, other part of the captured real-time images of the second video communication device 30 may be the real-time images of the local non-speaking users of the second video communication device 30. In some embodiments of the present invention, when the first user finishes speaking and another remote user speaks next, e.g., the second user of the second video communication device 30 or the third user of the third video communication device speaks next to the first user, the real-time images of the Object-of-Interest focused by the first user will not be removed immediately from the video conference screen or the field of view of the real-time images showing Object-of-Interest will not immediately return to the default view. Instead, the real-time images of the Object-of-Interest still remain on the video conference screens displayed by the video communication devices in the video conference for a period of time, e.g. 7 or 15 seconds. When the next speaker speaks, if the line-of-sight angle is also toward the real-time image of the first user's Object-of-Interest, the video communication device used by the speaking user will transmit the speaker's line-of-sight angle to the video communication device providing the real-time the images of first user's Object-of-Interest, for example, the second video communication device 30. After receiving the speaker's line-of-sight angle, the second processing circuit 300 controls the second image capture circuit 302 to keep capturing the real-time images with fields of view same as when the first user speaks. Otherwise, the second processing circuit 300 adjusts the field of view of the second image capture circuit 302 according to the new line-of-sight angle of the next speaker, or returns the field of view to the default. If the next speaker does not focus on the real-time images provided by the second video communication device 30 on the video conference screen, the video communication device used by the next speaker notifies the second video communication device 30 to provide the real-time images with default view, such as the view of local users, or to stop providing multi-angle real-time image. In addition, the video communication device used by the next speaker notifies the video communication device, providing the real-time images on the video conference screen focused by the next speaker, with the next speaker's line-of-sight angle. For example, one of the first video communication device 20, the third video communication device or the fourth video communication device, provides the real-time images focused by the next speaker, will adjust the field of the view of image capture circuit according to the line-of-sight angle of the next speaker and capture real-time images accordingly. In the embodiments of the present invention, the real-time image of the speaking user and the captured real-time images with field of view adjusted according to the speaker's line-of-sight angle will be assigned with a higher priority by the server 10, so these high priority real-time images can dynamically occupy larger screen areas or screen areas closer to the center of the video conference screen displayed by the video communication devices. The real-time images of other non-speaking users or not being focused by the speaker will be assigned with a lower priority by the server 10. These low priority real-time images dynamically occupy smaller screen areas or peripheral screen areas on the video conference screen.

It should be noted that the video conference system 1 is the embodiment of the present invention. Those skilled in the art should readily make combinations, modifications and/or alterations on the abovementioned description and examples. The abovementioned description, steps, procedures and/or processes including suggested steps can be realized by means that could be hardware, software, firmware (known as a combination of a hardware device and computer instructions and data that reside as read-only software on the hardware device), an electronic system, or combination thereof. Examples of hardware can include analog, digital and mixed circuits known as microcircuit, microchip, or silicon chip. Examples of the electronic system may include a system on chip (SoC), system in package (SiP), a computer on circuit (COM) and the video conference system 1. Any of the abovementioned procedures and examples above may be compiled into program codes or instructions that are stored in a memory. The memory may include read-only memory (ROM), flash memory, random access memory (RAM), subscriber identity circuit (SIM), hard disk, or CD-ROM/DVD-ROM/BD-ROM, but not limited thereto. The processing circuit may read and execute the program codes or the instructions stored in the memory for realizing the abovementioned functions.

In summary, the video conference system of the present invention may assign the identities and priorities of the host video communication device and the participant video communication device, and the participant video communication device may adjust the second video screen according to the host information. In this way, the host video communication device may display the adjusted second video screen. For example, the adjusted second video screen focuses on the samples, whiteboards or other objects on the scene at the second. The host may clearly focus on or explain the image content of important objects in the second video screen, and other participants may also see the adjusted second video screen at the same time, and instantly know what the host is paying attention to or explaining.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network video communication device, comprising:
a transmission circuit;
a display;
an image capture circuit, for capturing a first real-time image; and
a processing circuit, coupled to the transmission circuit, the image capture circuit and the display; wherein the network video communication device performs following steps:
controlling, by the processing circuit, the transmission circuit to connect a server and join an online video conference as one of a plurality of participants of the online video conference;
controlling, by the processing circuit, the image capture circuit to capture the first real-time image of a first user local to the network video communication device;
receiving, by the transmission circuit, a second video signal, wherein the second video signal comprise a second real-time image captured by a second video communication device which is another one of the participants of the online video conference;
controlling, by the processing circuit, the display to display a video conference screen, wherein the video conference screen comprises the second real-time image;
determining, by the processing circuit, an identity or a status of the first user corresponding to the online video conference;
processing, by the processing circuit, the first real-time image of the first user to generate a first user information, wherein the first user information comprises an eye gaze direction of the first user if the identity or the status of the first user meets a requirement;
controlling, by the processing circuit, the transmission circuit to transmit the first user information to the second video communication device;
receiving, by the transmission circuit, the second video signal comprising the adjusted real-time image with an adjusted field of view, wherein the adjusted field of view is directed to a focus area corresponding to the eye gaze direction of the first user;
controlling, by the processing circuit, the display to display the second real-time image with the adjusted field of view in the video conference screen;
wherein the second real-time image with the adjusted field of view is transmitted to the participants of the online video conference.

2. The network video communication device of claim 1, wherein the image capture circuit comprises a plurality of photographic lenses for capturing a plurality of images, wherein the processing circuit selects at least one of the captured images to be processed and generates the first real-time image.

3. The network video communication device of claim 1, wherein the image capture circuit comprises an upper photographic lens, a bottom photographic lens, a middle photographic lens, a left photographic lens and a right photographic lens, and the image capture circuit covers a field of view more than 130 degrees horizontally and 105 degrees vertically.

4. The network video communication device of claim 1, wherein the step of processing, by the processing circuit, the first real-time image of the first user to generate the first user information comprises:
performing edge detection on the first real-time image for detecting a user face position;
detecting eye characteristics for determining a user eye position corresponding to the user face position on the first real-time image; and
determining the user gazing direction according to the user eye position.

5. The network video communication device of claim 4, wherein the step of processing, by the processing circuit, the first real-time image of the first user to generate the first user information further comprises:
calculating a user distance based on user face size information corresponding to the user face position on the first real-time image and focal length information of the image capture circuit.

6. The network video communication device of claim 4, wherein the step of determining the user gazing direction according to the user eye position comprises:
determining a horizontal face midline and a vertical face midline of a user face at the user face position; and
comparing the user's eye positions with the horizontal face midline and the vertical face midline of the user face.

7. The network video communication device of claim 1, further comprising:
a microphone, wherein the microphone receives a first real-time audio local to the network video communication device, and the processing circuit processes the first real-time audio to determine a direction and the status of the first user.

8. The network video communication device of claim 1, wherein the identity or the status of the first user meets the requirement when the identity of the first user is a host of the online video conference or the status of the first user is current speaker of the online video conference.

9. A network video communication device, comprising:
a transmission circuit;
an image capture circuit, for capturing real-time images; and
a processing circuit, coupled to the transmission circuit and the image capture circuit;
wherein the network video communication device performs following steps:
controlling, by the processing circuit, the transmission circuit to connect a server and join an online video conference as one of a plurality of participants of the online video conference;
controlling, by the processing circuit, the image capture circuit to capture a first real-time image of a user local to the network video communication device;
transmitting, by the transmission circuit, the first real-time image to at least one of the other participants of the online video conference;
receiving, by the transmission circuit, a first user information from a remote network video communication device, wherein the first user information comprises an eye gaze direction of a remote user of the remote network video communication device, the remote user is recognized as having a first identity or in a first status corresponding to the online video conference, and the remote video communication device is the at least one of the other participants of the online video conference;
processing, by the processing circuit, the first user information and controlling the image capture circuit to capture a second real-time image, wherein the second real-time image is captured with a field of view adjusted corresponding to the eye gaze direction of the remote user; and
transmitting, by the transmission circuit, a video signal including the second real-time image with the adjusted field of view to the at least one of the other participants of the online video conference.

10. The network video communication device of claim 9, wherein the image capture circuit comprises a plurality of photographic lenses for capturing a plurality of images, wherein the processing circuit selects at least one of the captured images according to the first user information to merge into the second real-time image.

11. The network video communication device of claim 9, wherein the image capture circuit comprises an upper photographic lens, a bottom photographic lens, a middle photographic lens, a left photographic lens and a right photographic lens, and the image capture circuit covers a field of view more than 130 degrees horizontally and 105 degrees vertically.

12. The network video communication device of claim 9, wherein the network video communication device further performs following step:
performing, by the processing circuit, edge detection on the second real-time image with the adjusted field of view and determining an object-of-interest in the second real-time image with the adjusted field of view; and
controlling, by the processing circuit, the image capture circuit to zoom-in and capture an enlarged image of the object-of-interest as the second real-time image with the adjusted field of view.

13. The network video communication device of claim 9, wherein the first identity of the remote user is a host of the online video conference, and the first status of the remote user is current speaker in the online video conference.

14. The network video communication device of claim 9, further comprising: a display,
wherein the transmission circuit receives a video signal including a remote real-time image and the processing circuit controls the display to display the remote real-time image in a video conference screen.

15. The network video communication device of claim 9, wherein the network video communication device further performs the following steps:
controlling, by the processing circuit, the image capture circuit to capture the first real-time image with a previous field of view and the second real-time image with the adjusted field of view at the same time; and
transmitting, by the transmission circuit, the video signal including the first real-time with the previous field of view and the second real-time image with the adjusted field of view to the at least one of the other participants of the online video conference.

16. A method of video conference image processing, for a network video communication device comprising a transmission circuit, a display, an image capture circuit, a microphone and a processing circuit, the method of video conference image processing comprising:
connecting a server and joining an online video conference as one of a plurality of participants of the online video conference, wherein the participants of the online video conference comprise at least the network video communication device and a second video communication device remote to the network video communication device;
capturing a first real-time image of a first user local to the network video communication device;
capturing a first real-time audio local to the network video communication device;
receiving a second video signal, wherein the second video signal comprise a second real-time image captured by the second video communication device;
displaying a video conference screen including the second real-time image;
determining an identity of the first user corresponding to the online video conference, or determining a status of the first user based on the first real-time image of the first user or the first real-time audio;
processing the first real-time image of the first user to generate a first user information if the identity or the status of the first user meets a requirement, wherein the first user information comprises an eye gaze direction of the first user;
transmitting the first user information to the second video communication device;
receiving the second video signal comprising the second real-time image with an adjusted field of view, wherein the adjusted field of view is directed to a focus area corresponding to the eye gaze direction of the first user; and
displaying the video conference screen including the second real-time image with the adjusted field of view.

17. The method of video conference image processing of claim 16, wherein the step of processing the first real-time image of the first user to generate the first user information comprises:
performing edge detection on the first real-time image for detecting a user face position;
detecting eye characteristics for determining a user eye position corresponding to the user face position on the first real-time image; and
determining the user gazing direction according to the user eye position.

18. The method of video conference image processing of claim 17, wherein the step of processing the first real-time image of the first user to generate a first user information comprises:
calculating a user distance based on user face size information corresponding to the user face position on the first real-time image and focal length information of the image capture circuit.

19. The network video communication device of claim 17, wherein the step of determining the user gazing direction according to the user eye position comprises:
determining a horizontal face midline and a vertical face midline of a user face at the user face position; and
comparing the user's eye positions with the horizontal face midline and the vertical face midline of the user face.

20. The method of video conference image processing of claim 16, further comprising:
receiving a first real-time audio local to the network video communication device, and processing the first real-time audio to determine a direction and the status of the first user.

21. The method of video conference image processing of claim 16, wherein the identity or the status of the first user meets the requirement when the identity of the first user is a host of the online video conference or the status of the first user is current speaker of the online video conference.

22. The method of video conference image processing of claim 16, wherein the step of displaying the video conference screen including the second real-time image with the adjusted field of view comprises:
receiving a priority for the second real-time image with the adjusted field of view; and
arranging a screen area in the video conference screen corresponding to the received priority.
